(19) United States
(12) Patent Application Publication
(10) Pub. No.: US 2017/0240450 A1
(43) Pub. Date: Aug. 24, 2017

(54) INDUCTION MELTER FOR GLASS MELTING AND SYSTEMS AND METHODS FOR CONTROLLING INDUCTION-BASED MELTERS

(71) Applicant: PPG Industries Ohio, Inc., Cleveland, OH (US)

(72) Inventors: Jian Meng, Gastonia, NC (US); Guosheng Kang, Allison Park, PA (US)

(21) Appl. No.: 15/504,070

(22) PCT Filed: Aug. 21, 2015
(86) PCT No.: PCT/US15/46241

§ 371 Date: Feb. 15, 2017

Related U.S. Application Data
(60) Provisional application No. 62/040,223, filed on Aug. 21, 2014.

(51) Int. Cl. C03B 5/02; C03B 5/26; C03B 37/02; C03B 5/182; C03B 5/225; C03B 5/24

(52) U.S. Cl. CPC C03B 5/021; C03B 5/2252; C03B 5/24; C03B 37/02; C03B 5/182; C03B 5/262

(57) ABSTRACT

Described herein are systems and methods for heating and melting glass through the use of induction based heating and methods for forming a fiberglass strand. An exemplary induction melter system for melting glass can include a melting vessel and a heated drain. The melting vessel can include a crucible, a first induction coil positioned around at least a portion of the crucible, and a first electromagnetic current generator coupled to the first induction coil. The heated drain can be coupled to the melting vessel, and the heated drain can include a drain tube, a second induction coil positioned around at least a portion of the drain tube, and a second electromagnetic current generator coupled to the second induction coil.

### CROSS REFERENCE TO RELATED APPLICATIONS

This application claims priority to U.S. Provisional Patent Application Ser. No. 62/040,223, filed on Aug. 21, 2014, which is hereby incorporated by reference as though fully set forth herein.

### GOVERNMENT INTEREST

This invention was made with government support under contract W911NF-09-9-0003 awarded by the United States Army Research Laboratory. The government has certain rights in the invention.

### FIELD OF THE INVENTION

The present invention relates generally to systems for induction melting and fining and methods for controlling induction based melters. In particular, to methods and systems for operating and controlling an induction based melter for producing fiber glass.

### BACKGROUND OF THE INVENTION

Glass fibers are produced by first melting a glass feedstock and then drawing multiple streams of molten glass at a given rate of speed through orifices or nozzles located in a heated container. The fibers drawn from the orifices or nozzles are gathered after they solidify into one or more strands and wound into one or more packages.

Traditional methods rely on electrical resistance and/or combustion to generate heat to melt glass feedstock. Often these methods cannot maintain the necessary temperature for high quality and high production specialty fiber glass products. Thus, there is a need for improved systems and methods for heating and melting glass.

### SUMMARY

Some embodiments of the present invention can provide systems and methods for heating and melting glass through the use of an induction based heating method.

In some embodiments, an induction melter system for melting glass comprises a melting vessel and a heated drain. In some such embodiments, the melting vessel comprises a crucible, a first induction coil positioned around at least a portion of the crucible, and a first electromagnetic current generator coupled to the first induction coil such that the electromagnetic current travels through the first induction coil to provide heat to the crucible. In some such embodiments, the heated drain is coupled to the melting vessel, and the heated drain comprises a drain tube, a second induction coil positioned around at least a portion of the drain tube, and a second electromagnetic current generator coupled to the second induction coil such that the electromagnetic current travels through the second induction coil to provide heat to the drain tube.

In some embodiments, the crucible of the induction melter system comprises a Pt—Rh alloy material. In some embodiments, the melting vessel comprises an agitator positioned in the crucible. In some embodiments, the crucible comprises a plate positioned in an interior of the crucible dividing a portion of the crucible into a first side and a second side, and a tubular structure positioned in the interior of the crucible. In some such embodiments, the tubular structure has a first end comprising an opening and a second end positioned at a bottom end of the crucible. Glass material can be inserted into the crucible on the first side of the crucible and heated such that molten glass flows to the opening at the first end of the tubular structure that is positioned on the second side of the crucible.

In some embodiments, the heated drain can comprise a plunger. In some embodiments, the heated drain can comprise a bulb structure positioned in the drain tube. The bulb structure can be heated by the second induction coil to provide a heated surface such that molten glass discharged from the melting vessel flows over the heated surface of the bulb structure. In some such embodiments, the heated surface of the bulb structure is configured to remove seeds from molten glass discharged from the melting vessel.

In some embodiments, the induction melter system comprises a controller configured to control one or more of the current, voltage, or frequency applied to at least one of the first induction coil and the second induction coil. In some aspects, the controller can modify one or more of the current, voltage, or frequency applied to at least one of the first induction coil and the second induction coil based in part on the amount of glass introduced to the crucible. In some aspects, the controller can modify one or more of the current, voltage, or frequency applied to at least one of the first induction coil and the second induction coil based in part on the amount of glass fibers produced by a bushing. In some aspects, the controller can modify one or more of the current, voltage, or frequency applied to at least one of the first induction coil and the second induction coil based in part on the amount of molten glass in a refiner. In some aspects, the controller can modify one or more of the current, voltage, or frequency applied to at least one of the first induction coil and the second induction coil based in part on the temperature of one or more of the crucible, the drain, the refiner, or the bushing.

In some embodiments, the first electromagnetic current generator and the second electromagnetic current generator are the same electromagnetic current generator. In other embodiments, the first electromagnetic current generator and the second electromagnetic current generator are different electromagnetic current generators.

In other embodiments, a system for forming a fiber glass strand is described herein. In some embodiments, a system for forming a fiber glass stand comprises an induction melter system, a refiner, a bushing, and a winder. In some such embodiments, the induction melter system comprises a melting vessel and a heated drain. In some such embodiments, the melting vessel comprises a crucible, a first induction coil positioned around at least a portion of the crucible, and a first electromagnetic current generator coupled to the first induction coil such that the electromagnetic current travels through the first induction coil to provide heat to the crucible. In some such embodiments, the heated drain is coupled to the melting vessel, and the heated drain comprises a drain tube, a second induction coil positioned around at least a portion of the drain tube, and a second electromagnetic current generator coupled to the second induction coil such that the electromagnetic current travels through the second induction coil to provide heat to the drain tube. Molten glass discharged from the heated drain flows to the refiner. After the refiner, the molten glass discharged from the refiner flows to the bushing forming glass fibers, which are subsequently gathered into a strand by the winder.

In some embodiments, the refiner comprises a vacuum refiner. In some embodiments, the refiner can include a third induction coil positioned around at least a portion of the refiner and a third electromagnetic current generator coupled to the third induction coil such that electromagnetic current travels through the third induction coil to provide heat to the refiner.

In yet other embodiments, an apparatus for melting glass is described herein. In some embodiments, an apparatus for melting glass comprises a crucible comprising at least one outer wall defining an inner space, an induction coil positioned around at least a portion of the at least one outer wall of the crucible, and an electromagnetic current generator coupled to the induction coil such that the electromagnetic current travels through the induction coil to provide heat to the at least one outer wall of the crucible.

In some embodiments, the crucible comprises a Pt—Rh alloy material. In some embodiments, the apparatus further comprises an agitator positioned in the crucible. The agitator can be configured to stir or mix contents of the crucible. In some embodiments, the agitator releases gas into contents of the crucible to agitate the contents. In other embodiments, the agitator comprises a structure to stir mechanically the contents of the crucible to agitate the contents.

In yet other embodiments, a melter vessel is described herein. In some embodiments, a melter vessel comprises: a crucible having at least one outer wall defining an inner chamber and where the crucible comprises a first body region and a second bottom region, the first body region having a first dimension and the second bottom region having a conical shape; a plate positioned within the inner chamber of the crucible dividing the first body region of the crucible into a first side and a second side and where the plate has a second dimension, where the first dimension of the first body region of the crucible and the second dimension of the plate are substantially the same such that a channel is defined in the second bottom region of the crucible to permit flow of material from the first side of the crucible to the second side of the crucible; and a tubular structure positioned in the inner chamber of the crucible that traverses a portion of the first body region of the crucible and the entire second bottom region of the crucible and where the tubular structure has a first end comprising an opening and a second end positioned at a vertex of the conical shaped second bottom region of the crucible.

In some such embodiments, the first end of the tubular structure is positioned in the second side of the crucible. In some embodiments, the second end of the tubular structure is coupled to a drain. In some embodiments, glass inserted into the crucible on the first side of the crucible is heated such that molten glass flows to the second side of the crucible to the opening at the first end of the tubular structure.

In yet further embodiments, a method of making a fiber glass strand is described herein. In some embodiments, a method comprises: providing glass material to a crucible; providing electromagnetic current to a first induction coil positioned around at least a portion of the crucible to heat the crucible; discharging molten glass from the crucible to a heated drain; providing electromagnetic current to a second induction coil positioned around at least a portion of the drain to heat the drain; and discharging molten glass from the drain.

In some embodiments, the method of making a fiber glass strand further includes removing seed from the molten glass in the drain as the molten glass flows over a surface of a bulb structure positioned in the drain. In some embodiments, the method of making further includes providing the molten glass to a refiner that is coupled to the drain; providing the molten glass from the refiner to a bushing coupled to the refiner to form glass fibers; and winding the glass fibers formed by the bushing into a strand.

In some embodiments, the method of making a fiber glass strand can include controlling at least one or more of the current, voltage, or frequency applied to at least one of the first induction coil and the second induction coil by a controller. In some aspects, the controller can modify one or more of the current, voltage, or frequency applied to at least one of the first induction coil and the second induction coil based in part on the amount of glass introduced to the crucible. In some aspects, the controller can modify one or more of the current, voltage, or frequency applied to at least one of the first induction coil and the second induction coil based in part on the amount of glass fibers produced by a bushing. In some aspects, the controller can modify one or more of the current, voltage, or frequency applied to at least one of the first induction coil and the second induction coil based in part on the amount of molten glass in a refiner. In some aspects, the controller can modify one or more of the current, voltage, or frequency applied to at least one of the first induction coil and the second induction coil based in part on the temperature of one or more of the crucible, the drain, the refiner, or the bushing.

In some embodiments, the method of making a fiber glass strand can include the crucible producing more than 40 pounds of molten glass per hour.

These and other embodiments are presented in greater detail in the Detailed Description which follows.

### BRIEF SUMMARY OF THE FIGURES

FIG. 1 is a schematic diagram of a system for induction melting according to an embodiment of the present invention.

FIG. 2 is a cross-sectional view of an induction melter system according to an embodiment of the present invention.

FIG. 3 is a cross-sectional view of an induction melter system according to an embodiment of the present invention.

FIG. 4 is a cross-sectional view of a heated drain portion of an induction melter system according to an embodiment of the present invention.

FIG. 5A is a perspective view of a cross-section of a melter vessel according to an embodiment of the present invention.

FIG. 5B is a side view of a cross section of a melter vessel according to an embodiment of the present invention.

FIG. 6 is a schematic diagram of a system for induction melting according to an embodiment of the present invention.

### DETAILED DESCRIPTION

The subject matter of embodiments of the present invention is described herein with specificity to meet statutory requirements, but this description is not necessarily intended to limit the scope of future claims. The subject matter to be claimed may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. The illustrative examples are given to introduce the reader to the general subject matter discussed herein and not intended to limit the scope of the disclosed concepts. The following sections describe various additional embodiments and examples with reference to the drawings in which like numerals indicate like elements and directional description are used to describe illustrative embodiments but, like the illustrative embodiments, should not be used to limit the present invention.

Unless indicated to the contrary, the numerical parameters set forth in the following specification are approximations that can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. Additionally, any reference referred to as being “incorporated herein” is to be understood as being incorporated in its entirety.

It is further noted that, as used in this specification, the singular forms “a,” “an,” and “the” include plural referents unless expressly and unequivocally limited to one referent.

Glass fibers can be formed from molten glass in a number of ways as will be discussed in more detail below. In a typical direct-melt fiber forming operation, a glass melting furnace and forehearth convey a stream of molten fiberizable material to an outlet fitted with a metallic bushing attached to the bottom of the forehearth.

For example, glass fibers can be formed in a direct-melt fiber forming operation or in an indirect, or marble-melt, fiber forming operation. In a direct-melt fiber forming operation, raw materials are combined, melted and homogenized in a glass melting furnace. The molten glass moves from the furnace to a forehearth and into fiber forming apparatuses, such as bushings, where the molten glass is attenuated into continuous glass fibers. In a marble-melt glass forming operation, pieces or marbles of glass having the final desired glass composition are preformed and fed into a bushing where they are melted and attenuated into continuous glass fibers. If a premelter is used, the marbles are fed first into the premelter, melted, and then the melted glass is fed into a fiber forming apparatus, such as a bushing, where the glass is attenuated to form continuous fibers. Further, for additional information relating to glass compositions and methods of forming the glass fibers, see K. Lowenstein, The Manufacturing Technology of Continuous Glass Fibres, (3d Ed. 1993), at pages 30-44, 47-103, and 115-165, which are specifically incorporated by reference herein.

The molten glass flows from the bottom of the bushing through a large number of orifices or “tips” in a tip plate where they can be attenuated by a winder to form glass filaments of desired size. The filaments can then be contacted with an applicator to apply a sizing composition, gathered by a guide to form a sliver or strand, and wound about a collet of a winder. Examples of suitable sizing compositions and winders are set forth in

Loewenstein (supra) at pages 186-194 and 237-287. As sizing compositions are generally applied after formation of glass filaments, embodiments of the present invention can generally be implemented in manufacturing processes where any number of sizing compositions (or no sizing composition) are applied to the glass filaments, and the present invention is not intended to be limited to any particular sizing composition. Similarly, the present invention is not intended to be limited to manufacturing processes where any particular winder is used. As is known to those of skill in the art, winders are not required in all processes for forming fiber glass products as the glass fibers can be provided directly to other processing equipment.

Some conventional methods for producing fiber glass on a small scale (i.e., not using a furnace, forehearth, etc.) typically use resistance based heating to melt glass marbles. The molten glass is then fed through various components and a porous bushing to produce glass fibers. These fibers are then gathered to form a fiber glass strand and wound.

Resistance based heating may have drawbacks because it takes time for the resistance heaters to reach a desired temperature. Further, there may be significant heat loss associated with resistance based heaters. Therefore, it can be very challenging to maintain glass temperatures above certain temperatures (e.g., 2600° F. (1427° C.)). Thus, such resistance based heating systems and devices are limited in the types of fiber glass (e.g., those types having lower liquidus and/or forming temperatures) and the amount of glass they can produce. This may be caused by heat loss and the amount of energy required to melt large amounts of glass. For example, some resistance-based melters can operate at only about 10 pounds of glass per hour or less. Often conventional melters can take an extended time to heat up to the proper temperature or may frequently fail due to excessive heat load and thermal stress on the terminal connectors. Often, the result of using conventional melts is discontinuous product which leads to low production rates.

Some embodiments of the present invention provide solutions to overcome one or more of these problems with conventional methods of producing fiber glass. Some embodiments of the present invention address at least some of these problems through the use of an induction based heating method. Hot-wall induction melting technology is a process of melting material with a wall that is heated by an electromagnetic induction field. Induction heating refers to the process of heating an electrically conducting object (usually a metal) by electromagnetic induction, where eddy currents (also called Foucault currents) are generated within the metal and resistance heats the metal. A hot-wall induction melter of the present disclosure consists of a crucible or melter vessel, an induction coil (e.g., a copper coil), and an electromagnetic current generator. In some embodiments, an induction melter may comprise a Pt—Rh alloy vessel that is used for melting batch/glass. In some embodiments, an induction melter may be used for single batch production or continuous operation.

Some embodiments of the present invention relate to induction melters and to methods for utilizing an induction melter. In one embodiment, an induction melter comprises a crucible and an induction coil. In a further embodiment of the present invention, the induction coil is configured to induce a current in the crucible. In a further embodiment of the present invention, the induced current is configured to heat the crucible.

In a further embodiment of the present invention, the crucible is configured to melt glass or glass batch materials. In a further embodiment of the present invention, the glass or glass batch materials are not pre-heated prior to entering the crucible.

In a further embodiment of the present invention, the crucible is configured to produce more than 40 pounds of molten glass per hour.

In a further embodiment of the present invention, the crucible comprises an agitator. In a further embodiment of the present invention, the agitator is configured to stir molten glass. In a further embodiment of the present invention, the agitator comprises a bubbler. In a further embodiment of the present invention, the agitator comprises a device configured to release a gas into the molten glass. In a further embodiment of the present invention, the agitator comprises a device configured to release an inert gas such as nitrogen or air intentionally for creating an oxidizing environment in the molten glass into the molten glass. In a further embodiment of the present invention, the agitator comprises a mechanical stirrer.

In a further embodiment of the present invention, the crucible is coupled to a drain. In a further embodiment of the present invention, the drain comprises a drain tube. In a further embodiment of the present invention, the drain is coupled to a second induction coil. In a further embodiment of the present invention, the second induction coil is configured to induce a current in the drain. In a further embodiment of the present invention, the current is configured to heat the drain.

In a further embodiment of the present invention, the drain comprises a plunger (e.g., a plunger constructed from iridium) for adjustment of the drain.

In a further embodiment of the present invention, the drain comprises a component configured to remove seeds. In some embodiments, the component configured to remove seed comprises a bulb shaped device. In a further embodiment of the present invention, the bulb shaped device is configured to cause a thin layer of glass to flow over its surface. In a further embodiment of the present invention, the bulb shaped device is configured to remove bubbles or seeds in molten glass.

In a further embodiment of the present invention, the drain is coupled to a refiner. In a further embodiment of the present invention, the refiner comprises a vacuum refiner. In a further embodiment of the present invention, the refiner is configured to further remove seeds. In a further embodiment of the present invention, the refiner comprises a heated refiner. In a further embodiment of the present invention, the heated refiner is configured to be heated by induction or electrical resistance heating. In a further embodiment of the present invention, the heated refiner is coupled to a third induction coil. In a further embodiment of the present invention, the third induction coil is configured to induce a current in the heated refiner.

In a further embodiment of the present invention, the refiner is coupled to a bushing. In a further embodiment of the present invention, the bushing comprises a heated bushing. In a further embodiment of the present invention, the bushing comprises a plurality of holes or tips. In a further embodiment of the present invention, the bushing is configured to form glass fibers. In a further embodiment of the present invention, a winder is configured to gather the glass fibers into a strand.

In a further embodiment of the present invention, a controller is configured to control one or more of the current, voltage, or frequency applied to each of the coils. In a further embodiment of the present invention, the controller is configured to modify the one or more of the current, voltage, or frequency applied to each of the coils based in part on the amount of glass introduced to the crucible. In a further embodiment of the present invention, the controller is configured to modify the one or more of the current, voltage, or frequency applied to each of the coils based in part on the amount of glass fibers produced by the bushing. In a further embodiment of the present invention, the controller is configured to modify the one or more of the current, voltage, or frequency applied to each of the coils to allow the combination to produce more than 40 pounds of fiberglass per hour. In a further embodiment of the present invention, the controller is configured to modify the one or more of the current, voltage, or frequency applied to each of the coils based in part on the temperature of one or more of the crucible, the drain, the refiner, or the bushing.

An induction heater may be desirable because of its simplicity, efficiency, and high temperature capability. In some embodiments, an induction melter of the present invention may be able to maintain glass at a temperature of at or above 2600° F. (1427° C.), even at production rates of more than 10 pounds per hour. For example, such an induction melter may be able to handle production rates of more than 40 pounds per hour. Such capabilities of embodiments of induction melters of the present invention enable melting and fining of glass compositions having relatively high liquidus and forming temperatures for specialty fiber glass products such as high strength fibers. Further, some induction melters of the present invention can be advantageously used in the production of glass fibers having high melt properties (e.g., those that well exceed the E-glass liquidus and forming temperatures), such as high strength glasses. Non-limiting examples of such glasses include: glasses having low dielectric constants, glasses having high strength and/or high modulus, glasses having high elongation, glasses having low coefficients of thermal expansion, and others. Non-limiting examples of glass compositions that can be used to form some such glasses can be found, for example, in U.S. Pat. No. 8,697,591 and U.S. Pat. No. 8,901,020, each of which are hereby incorporated by reference.

In some embodiments, induction melters of the present invention can be scaled up to have the production capacity to feed a single commercial production bushing. In some embodiments, this may lead to an “intensified reactor”-like fiber forming platform for development projects or can be provided in groups for commercial production.

In some embodiments of the present invention, an induction melter comprises a crucible and an induction coil. The term crucible can also be referred to herein as a melting crucible, melting vessel, or melter vessel. The induction coil may be configured to receive an oscillating current and induce currents in the crucible. These currents may heat the crucible and melt substances within the crucible (e.g., glass). In some embodiments, the crucible may comprise an agitator to ensure that the molten glass circulates and melts evenly. In some embodiments, this agitator may be configured to inject bubbles of a gas such as, an inert gas, nitrogen, air, oxygen, carbon dioxide, etc., such that the bubbles agitate and act to “stir” the molten glass. Further these bubbles may act to oxidize the glass if air or oxygen is injected.

In some embodiments, the crucible may comprise in part, a platinum and rhodium alloy.

The crucible is configured to receive a feed-stock for fiber forming. In some embodiments, this feed-stock may comprise a glass based stock for forming fiber glass. In some embodiments, this may comprise glass marbles. In some embodiments, the feed stock comprises batch materials in the form used in a conventional glass furnace. Further, in some embodiments, the feed-stock does not have to be pre-heated. Further, in some embodiments, the feed rate for the feed-stock may be controlled using conventional techniques and can be adjusted based on the throughput of glass fibers or the level of molten glass in the refiner according to techniques known to those of skill in the art. Further, in some embodiments, the increased heat capability of an induction melter may enable the melter to produce glass fibers at a rate exceeding 40 pounds per hour. Further, in some embodiments, the increased heat capability of an induction melter may enable the melter to receive feed-stock at a rate equal to or exceeding 40 pounds per hour.

In some embodiments, induction melters of the present further comprise a drain coupled to the crucible. In some embodiments, the drain may be heated. Molten glass passes from the crucible into the heated drain. In some embodiments, the heated drain may comprise an induction coil configured to induce currents in the heated drain. This induced current may be configured to maintain the heat level of the molten glass as it passes through the drain. In some embodiments, the drain may comprise a tube or similar structure coupled to the lower portion of the crucible. In some embodiments, the tube may comprise a tube made, in part, of platinum and rhodium alloy.

In some embodiments, the heated drain may further comprise a bulb that interrupts the flow of molten glass. This bulb may be configured to remove seeds (air bubbles) from the molten glass. For example, in some embodiments, the bulb may be configured to allow a thin layer of molten glass to flow over its heated surface. This thin layer of hot glass may be maintained at a very low viscosity. In some embodiments, the bulb may cause the seeds to travel out of the molten glass and thus produce a more uniform product.

After passing through the heated drain, the molten glass may pass to a heated refiner (sometimes referred to as a fining box), which is again heated by induction heat or resistance heating. In some embodiments, additional seeds may be removed from the molten glass while in the refiner, e.g., glass may settle in the refiner such that seeds may be rise or settle out of the molten glass. A variety of refiners can be used in embodiments including, vacuum refiners or other types of refiners (e.g., a refiner that injects helium bubbles into molten glass to remove the smaller seeds). Non-limiting examples of vacuum refiners that can be used in some embodiments of the present invention are described in U.S. Pat. Nos. 4,600,426; 4,610,711; 4,633,481; 4,704,153; 4,738,938; 4,780,122; 4,794,860; 4,824,462; 4,849,004; 4,886,539; 4,919,697; and 4,919,700, and EP1648834 A2 each of which is specifically incorporated by reference herein. The molten glass may then pass through a bushing comprising a plurality of holes through which glass fibers are formed. The glass fibers may be gathered and then wound by a winder to form a fiber glass strand.

In some embodiments, each stage of the melter may comprise a controllable induction coil. For example, a controllable power source may provide a current to a coil. This controllable power source may be controlled by a processor configured to maintain uniform glass production. For example, the processor may be configured to maintain each stage at a certain temperature (e.g., at or above the forming temperature of the glass composition). Further, the processor may be configured to ensure that the amount of fiber produced matches the weight of glass feedstock provided to the induction melter (e.g., to help control the flow of feedstock to the melter and prevent overflow of the crucible). As another example, the processor may be configured to maintain the level of molten glass in the refiner at a certain level.

In some embodiments, the processor described above may comprise a COMM PLC. In other embodiments, the processor can be other devices known to those of skill in the art for providing instructions related to the control of current. An example of another such device is a computer system. The computer system can run appropriate custom-designed or conventional software to carry out various embodiments of the present invention. For example, instructions related to controlling an induction melter can be written in the Visual Basic programming language and executed on the computer system based on data received by the computer system. The specific hardware, firmware and/or software utilized in the system need not be of a specific type but may be any such conventionally available items designed to perform the method or functions of the present invention. The computer system described is an example of one suitable computer system for the practice of the invention.

An example of another such device is a programmable logic controller, or PLC. In some embodiments, both a computer system and a programmable logic controller can be used to control the current. Computer systems and programmable logic controllers may provide different advantages that can be advantageously combined in some embodiments of the present invention. Thus, in some embodiments, a controller can comprise a computer system, a programmable logic controller, or both a computer system and a programmable logic controller.

In some embodiments, the controller may vary the current, frequency, or voltage of the signal applied to the coil. Adjusting one or more of these parameters may control the current induced by the coil. This may change the temperature of the component coupled to the coil (e.g., the crucible, drain, or refiner). Further, in some embodiments, each coil may be controlled independently. Thus, for example, the coil coupled to the crucible may be controlled separately from the coil coupled to the drain. Thus, in some embodiments, each component may be kept at a different temperature. Further, in some embodiments, each component may be controlled based on another. For example, the temperature of the drain may be controlled to be at a level that is higher or lower than that of the crucible.

In some embodiments, the controller can comprise a communications programmable logic controller or COMM PLC. The COMM PLC may be in electronic communication with a computer system comprising software or programs that carry out various embodiments of the present inventions. For example, instructions related to controlling an induction melter can be written in the Visual Basic programming language and executed on the computer system based on data received by the computer system. The specific hardware, firmware and/or software utilized in the system need not be of a specific type but may be any such conventionally available items designed to perform the method or functions of the present invention. The COMM PLC may also be connected to an input/output device such as a monitor and keyboard, mouse, touchscreen, etc.

Volatilization products and other off-gasses may be vented into a hood mounted above the vessel and then drawn through a ductwork connected to the outside of a building. A separate water chiller can provide cooling water to the induction coils, heat stations, and power supply cabinets to prevent overheating.

In some embodiments, the crucible or melter vessel heats as a result of exposure to changing electro-magnetic fields generated by the heat station. The heat is transferred to glass batch and causes glass to melt. Several R-type thermocouples can be welded to a melter vessel wall to monitor the vessel temperature. A bubbler and a “bed” thermocouple can be positioned within the melt from above. The temperatures from the thermocouples can be used to control the operation in a PID loop. In addition to the thermocouples, in some embodiments, a pyrometer can be used to measure the skin temperature of molten glass in the vessel. For example, a small access hole through the insulating refractory can be provided for the pyrometer to read the skin temperature. One non-limiting example of a pyrometer that can be used in some embodiments is a Moldine 5 two-color optical pyrometer (e.g., Model 5R-1810-1-9-9-RA) commercially available from Ircon, Inc. The temperature measurements from such a pyrometer can also be used, in some embodiments, to control the temperature of the vessel and to control the induction power provided to the vessel. The vessel may be surrounded by a Zircar insulating cylindrical refractory sleeve as thermal insulation, and water-cooled copper coils through which the electric current is passed to produce the electro-magnetic field.

Control of the drain tube temperature can be achieved, in some embodiments, by making manual power input adjustments to the drain tube heating station based upon deviation of the selected control thermocouples' indicated value from the set point temperature. In some embodiments, the drain tube temperature can be controlled based on a level detector that monitors the glass level in the refiner. For example, if the glass level is too high or too low, the induction power exerted to the drain tube can be modified to manipulate the temperature (e.g., the higher the temperature, the lower the viscosity of the molten glass, and thus the more flow through the drain). One example of a level detector that can be used in some embodiments of the present invention is the Molten Glass Level—HighTemp Surveillance Camera commercially available from JM Canty, Ltd. In some embodiments, a small window can be provided in the roof of the refiner through which the level detector can monitor the level of molten glass in the refiner.

The present invention will be discussed generally in the context of its use in the production, assembly, and application of glass fibers, although one skilled in the art would understand that embodiments of the present invention can be useful in forming fibers from other fiberizable materials, such as inorganic substances, which can be drawn into fibers by attenuation through a nozzle. See Encyclopedia of Polymer Science and Technology, Vol. 6 at 506-507. As used herein, the term “fiberizable” means a material capable of being formed into a generally continuous filament.

Persons of ordinary skill in the art will recognize that the present invention can be implemented in the production, assembly, and application of a number of glass fibers. Non-limiting examples of glass fibers suitable for use in the present invention can include those prepared from fiberizable glass compositions such as “E-glass”, “A-glass”, “C-glass”, “S-glass”, “ECR-glass” (corrosion resistant glass), and fluorine and/or boron-free derivatives thereof. Further, induction melters of the present invention can be advantageously used in the production of glass fibers having high melt properties (e.g., those that well exceed the E-glass liquidus and forming temperatures), such as high strength glasses. Non-limiting examples of such glasses include: glasses having low dielectric constants, glasses having high strength and/or high modulus, glasses having high elongation, glasses having low coefficients of thermal expansion, and others. Non-limiting examples of glass compositions that can be used to form some such glasses can be found, for example, in U.S. Pat. No. 8,697,591 and U.S. Pat. No. 8,901,020, each of which are hereby incorporated by reference. The specific composition of the glass to be fiberized is not generally important to the present invention, and as such, embodiments of the present invention can be implemented in manufacturing processes for any number of fiberizable glass compositions.

Certain aspects of the present invention will now be discussed in connection with the attached Figures which illustrate some embodiments of the present invention. Although the description associated with the Figures will focus on embodiments shown in the Figures, it should be understood that only slight modifications need to be made to the components in order to provide composite glass materials embodying the inventive concepts described in this application.

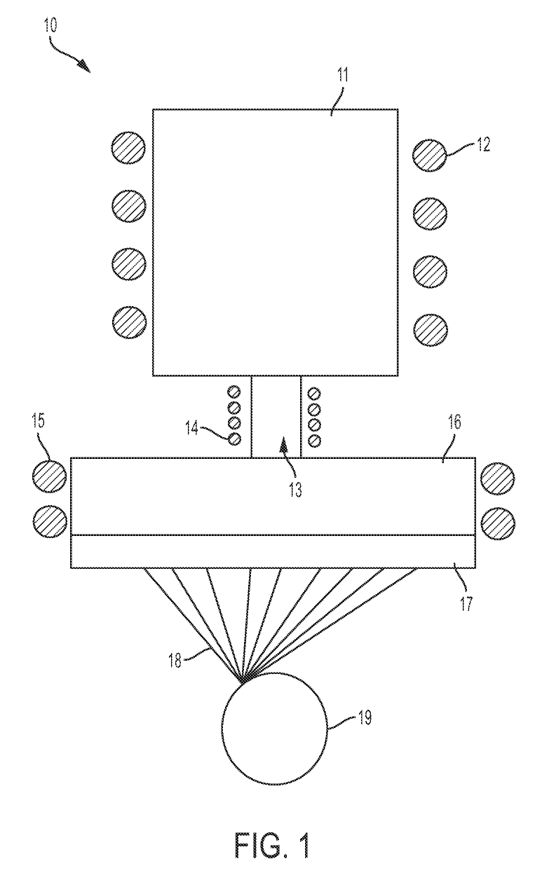

Turning now to FIG. 1, FIG. 1 illustrates a system for an induction melter according to one embodiment of the present invention. As shown in FIG. 1, the induction melter system 10 comprises a crucible 11, which is heated by an induction coil 12. As appreciated by one of ordinary skill in the art, FIG. 1 shows only a cross-section of the induction coil 12 as the induction coil 12 wraps or coils around the crucible 11. The induction coil 12 may be configured to receive an oscillating current and induce currents in the crucible 11. These currents may heat the crucible 11 and melt substances within the crucible 11, for example, glass. In some embodiments, the crucible 11 may comprise an agitator (not shown) to ensure that the molten glass circulates and melts evenly. In some embodiments, this agitator may be configured to inject bubbles of a gas, such as nitrogen, air, oxygen, carbon dioxide, etc., that agitate and act to “stir” the molten glass and adjust the oxidizing condition of the molten glass.

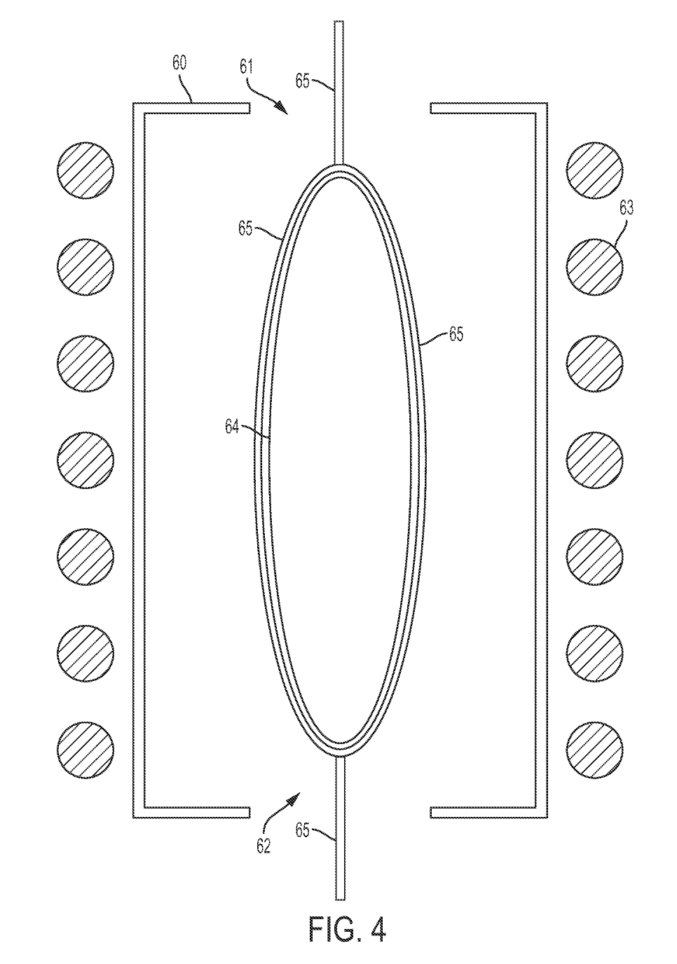

As shown in the system of FIG. 1, the molten glass passes from the crucible 11 through a heated drain 13. The heated drain 13 comprises an induction coil 14 configured to induce currents in the heated drain 13. This induced current may be configured to govern the heat level and the flow rate of the molten glass as it passes through the drain 13. For example, in some embodiments, a level detector can be provided to monitor the glass level in a refiner 16. If the glass level is too high or too low in the refiner 16, the induction power exerted to the drain 13 through the induction coil 14 can be modified to manipulate the temperature (e.g., the higher the temperature, the lower the viscosity of the molten glass, and thus the more flow through the drain 13). In some embodiments, for example, as shown in more detailed in FIG. 4, the heated drain 13 may comprise a bulb that diverts the flow of molten glass over the large hot surface of the bulb. This bulb may be configured to remove seeds (gas bubbles) from the molten glass. For example, in some embodiments, the bulb may be configured to allow a thin layer of molten glass to flow over its surface. This thin layer of molten glass flowing over the surface of the bulb may cause the seed to travel out of the molten glass and thus produce a more uniform product.

As shown FIG. 1, the molten glass passes through the heated drain 13 to the refiner 16. As shown in FIG. 1, the refiner 16 is heated by an induction coil 15. In some embodiments, additional seeds may be removed from the molten glass while in the refiner 16. The refiner 16 can reduce the temperature of the molten glass in preparation for further processing steps.

The molten glass next passes through a bushing 17 comprising a plurality of holes through which fiber glass strands 18 are formed. Persons of skill in the art can identify various bushings that can be implemented in connection with embodiments of the present invention. Non-limiting examples of suitable metallic materials for forming the components of the bushing include platinum, rhodium and alloys thereof. In some embodiments, the metallic material can be about a 10% to about 20% rhodium-platinum alloy, and in some embodiments, about 10% rhodium-platinum alloy. The metallic materials can be dispersion strengthened or grain-stabilized to reduce creep, if desired. Non-limiting examples of dispersion strengthened metal metallic plates are commercially available from Johnson Matthey, Inc., such as plates formed from its ZGS (Zirconia Grain Stabilized) platinum materials.

In one embodiment, the bushing 17 may comprise a G150 200-tip (0.066″ inner diameter tip). In some embodiments, the design of the bushing 17 is characteristic of bushings used by those of ordinary skill in the art during fiber glass production. In some embodiments, the bushing 17 may comprise a heated bushing with a temperature set at 1440° C. on top of the forming bushing.

The fiberglass strands 18 are then gathered and wound by a winder 19 to form a fiber glass strand. According to one embodiment, a commercial 12″ diameter fiber winding system may be used. In some embodiments, the winder speed may be set to 7850 fpm to generate G150 yield yarn (33 Tex) in 9 μm fiber diameter. In some embodiments, the package weight may be controlled at 10 pounds to allow easy handling in the downstream processing.

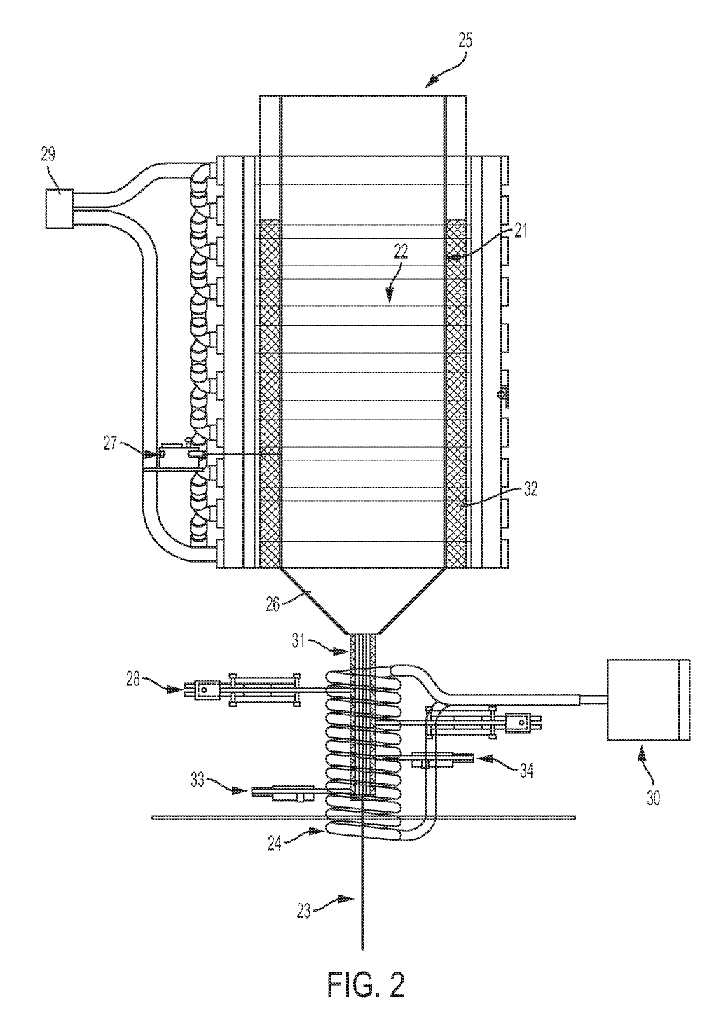

FIG. 2 shows an embodiment of an induction melter system according to another embodiment. In some embodiments, the induction melter crucible 21 may be made of platinum and rhodium alloy. Induction coil 22 wraps or coils around the crucible 21. The induction coil 22 can be operatively coupled to an electromagnetic current generator 29. The electromagnetic current generator 29 can be operably coupled to a controller that can adjust the amount of heat supplied to the crucible 21 based on different conditions. For example, thermocouple 27 can provide temperature related information to the controller to be used to adjust the amount of current supplied to the induction coil 22. The crucible 21 can further include insulation or other safety structures around the crucible 21. These components may be configured for high temperature glass melting operations. As shown in FIG. 2, in some embodiments, batch material is directly fed into the crucible 21 from a first end 25 and the molten glass is drained at a second end 26 of the crucible 21 through a thin tube discharger 23 (i.e., a drain). The second end 26 of the crucible 21 can have a conical shape to facilitate discharging of the molten glass to the heated drain coupled to the crucible 21.

In FIG. 2, the heated drain comprises a thin tube discharger 23, a second induction coil 24 wrapped around the drain. The induction coil 24 can be operatively coupled to an electromagnetic current generator 30. The electromagnetic current generator 30 can be operably coupled to a controller that can adjust the amount of heat supplied to the heated drain. In some embodiments, the heated drain can comprise insulation or safety structures 31, such as radiation shielding materials. Thermocouple 28 can provide temperature information to a controller (not shown) to be used to adjust the amount of current supplied to the induction coil 24. Air lines 33, 34 can provide vents and channels to output gas removed from the molten glass in the heated drain.

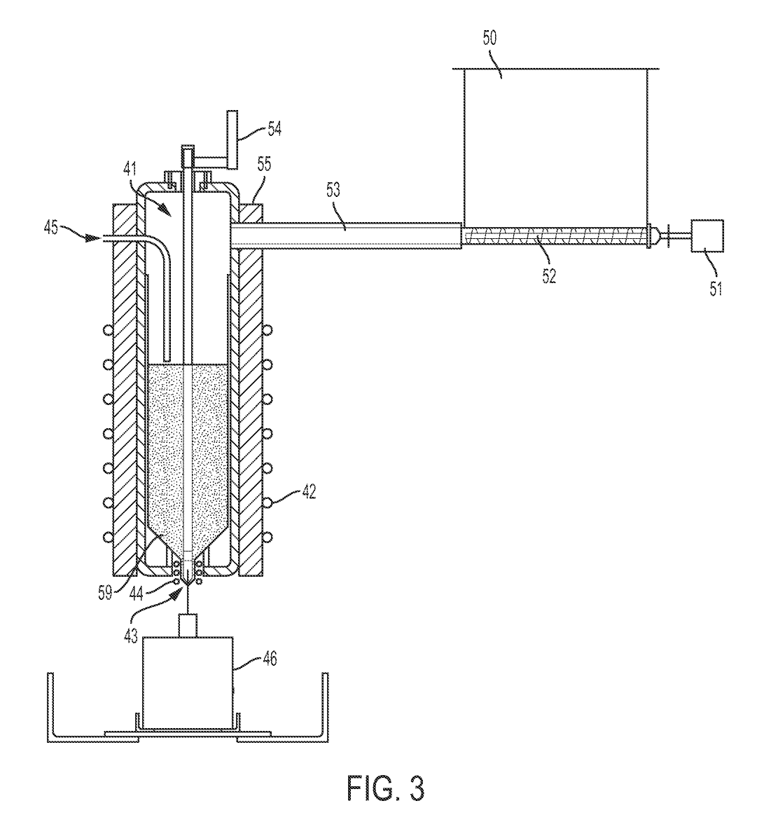

FIG. 3 shows other embodiments of an induction melter system. As shown in FIG. 3, raw glass batch ingredients are fed to the top of the crucible 41. The raw glass batch ingredients can be supplied to a container or hopper 50. An auger 52 or other transporting device (powered by a motor 51) can supply the contents from the hopper 50 laterally through a ceramic tube 53 to the top end of the crucible 41.

Induction coil 42 wraps or coils around the crucible 41. The induction coil 42 can be operatively coupled to an electromagnetic current generator (not shown). The electromagnetic current generator can be operably coupled to a controller that can adjust the amount of heat supplied to the crucible 41. For example, probe 45 can provide volume and temperature related information to the controller to be used to adjust the amount of current supplied to the induction coil 42. The crucible 41 can further include insulation or other safety structures 55 around the crucible 41. The molten glass 59 can be drained at a bottom end of the crucible 41 through a drain 43. The drain 43 can have a second induction coil 44 wrapped or coiled around the drain 43 to provide heat to the drain 43. Valve handle 54 can be operably connected to a plunger or other structure to open and close drain 43.

The molten glass 59 flows out from the bottom of the vessel by gravity through an inductively heated drain 43 into a fining chamber 46. In some embodiments as shown in FIG. 3, rather than allowing molten glass flowing from the bottom of the crucible by gravity freely, a plunger coupled to the valve handle 54 can be provided to control the flow of molten glass 59. In some such embodiments, the plunger can be constructed from iridium or an iridium alloy.

Machine parts and control elements according to exemplary embodiments are listed in Tables 1 and 2 below:

TABLE 1
Example Measurements of Components According to
One Embodiment of an Induction Melter.

| Device | Material | Dimension and Capacity |
|---|---|---|
| Induction Melter Crucible | Platinum Alloy | Φ = 6.0″-9.0″; H = 20″-24″ |
| Discharger | Platinum Alloy | Φ = 0.25-0.40″; H = 4″-6″; |
| | | 10-40 lbs./hour |
| Batch Feeder | Auger feeder | 10-40 lbs./hour |
| Glass Conditioner | Platinum Alloy | 4″ × 12″ × 8″ to 8″ × 16″ × 8″, |
| | | 10-40 lbs./hour |
| Bushing | Platinum Alloy | 10-40 lbs./hour |

TABLE 2
Example Measurements of One
Embodiment of an Induction Melter.

| | | Dimensions and |
|---|---|---|
| Unit | Application | Power Range |
| Primary Induction Power | Melter | Up to 75 kW |
| Melter Induction Coil | Melter | Φ = 9.0″-13″ |
| Secondary Induction | Discharger | Up to 30 kW |
| Power | | |
| Discharger Induction Coil | Discharger | Φ = 2.0″ |
| Transformer A | Glass Conditioner | Up to 30 kW |
| Transformer B | Bushing | Up to 30 kW |

Turning now to FIG. 4, FIG. 4 shows an embodiment that uses a bulb structure 64 for seed removal. In some embodiments, the bulb structure 64 may be constructed of a platinum-rhodium alloy. This bulb structure 64 may be configured to remove seeds (gas bubbles) from the molten glass 65. For example, in some embodiments, the bulb structure 64 may be configured to allow a thin layer of molten glass 65 to flow over its surface. The molten glass 65 can enter into the drain at a first end 61 and flow over the surface of the bulb structure 64 to the second end 62 of the drain. This thin layer may cause the seed to travel out of the molten glass 65 and thus produce a more uniform product. For example, in some embodiments, this film-like flow over the hot surface of the bulb structure 64 may be configured to cause the glass viscosity to be below 100 poises. Thus, the seeds may surface and migrate to ambient.

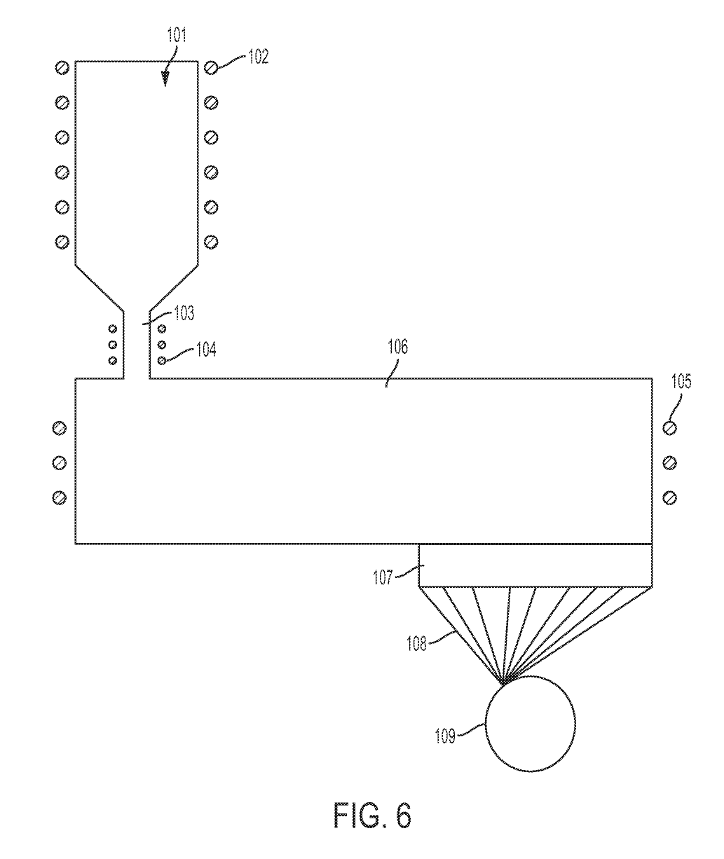

Further, in some embodiments, this bulb structure 64 may prevent air entrainment at the instant glass impacts the surface in the refiner. For example, in some embodiments as shown in FIG. 6, after the glass material is melted by the crucible 101 coupled to the induction coil 102, the refiner 106 is redesigned to enable glass discharged from the drain 103 (wrapped by induction coil 104) to flow horizontally through the refiner 106 (wrapped by induction coil 105) and then vertically down to bushing 107. The glass strands 108 formed by the bushing 107 can be wound by the winder 109. In such an embodiment, the refiner 106 may act as a glass conditioner that also enables further seed removal.

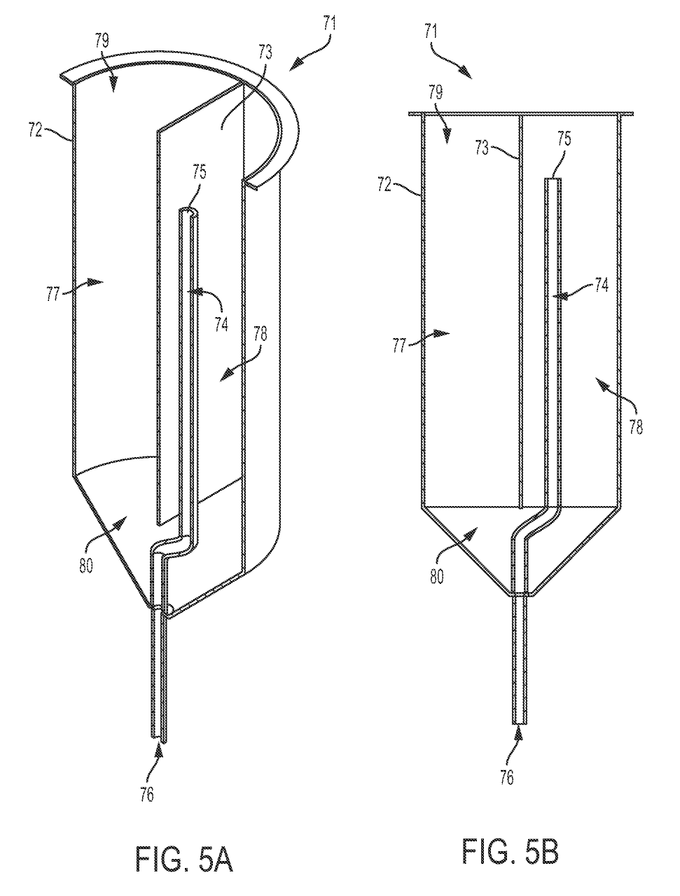

As shown in FIGS. 5A and 5B, in some embodiments, the melter vessel or crucible 71 can include a plate 73 which divides a first body region 79 of the melter vessel 71 into a first side 77 and a second side 78. An outer wall 72 of the melter vessel 71 defines an interior compartment of the melter vessel 71 including the first body region 79 and the second bottom region 80. The second bottom region 80 has a conical shape. The height of the first body region 79 and the height of the plate 73 are substantially the same such that the plate 73 stops at a lower portion of the melter vessel 71 to provide a channel for molten glass to flow from a first side 77 of the melter vessel 71 to the second side 78 of the melter vessel 71. The first side 77 can be batch-fed with glass material. Although not shown, a bubbler for agitation could be positioned on the first side 71. The molten glass can leave the first side 77 of the melter vessel 71 and enter the second side 78 of the melter vessel through the channel at the second bottom region 80 of the melter vessel 71. The molten glass rises to an overflow tube 74 near the glass surface to a first end 75 of the tube 74. The first end 75 includes an opening which provides access to the inner portion of the tube 74 that spans to the second end 76 of the tube 74. Such an arrangement enables a longer “U”-shaped path of glass flow in the melter vessel 71, and facilitates discharge of batch free glass through the discharge tube (or drain tube) which directs flow of the molten glass downwards to a fiber forming bushing device.

FIGS. 5A and 5B provide cross-sectional views in order to illustrate operation of the melter vessel 71 and the flow of molten glass within it. The other half of the vessel in this embodiment would be a mirror image of what is shown.

Advantages of some systems and methods for an induction melter may include a very low seed level, e.g., as low as 0.01 seed/cc. This may further allow for a very low strand break level of 0.20 breaks/hour or less. Further, some embodiments may allow for high flow rate of more than 40 pounds per hour.

It is to be understood that the present description illustrates aspects of the various embodiments of the invention relevant to a clear understanding of the invention. Certain aspects of the invention that would be apparent to those of ordinary skill in the art and that, therefore, would not facilitate a better understanding of the invention have not been presented in order to simplify the present description. Although the present invention has been described in connection with certain embodiments, the present invention is not limited to the particular embodiments disclosed, but is intended to cover modifications that are within the spirit and scope of the invention.

That which is claimed is:

1. An induction melter system for melting glass comprising:
a melting vessel comprising a crucible, a first induction coil positioned around at least a portion of the crucible, and a first electromagnetic current generator coupled to the first induction coil such that the electromagnetic current travels through the first induction coil to provide heat to the crucible;
a heated drain coupled to the melting vessel, the heated drain comprising a drain tube, a second induction coil positioned around at least a portion of the drain tube, and a second electromagnetic current generator coupled to the second induction coil such that the electromagnetic current travels through the second induction coil to provide heat to the drain tube.

2. The induction melter system of claim 1, wherein the crucible comprises a Pt—Rh alloy material.

3. The induction melter system of claim 1, wherein the melting vessel further comprises an agitator positioned in the crucible.

4. The induction melter system of claim 1, wherein the crucible further comprises:
a plate positioned in an interior of the crucible dividing a portion of the crucible into a first side and a second side;
a tubular structure positioned in the interior of the crucible, the tubular structure having a first end comprising an opening and a second end positioned at a bottom end of the crucible.

5. The induction melter system of claim 4, wherein glass material inserted into the crucible on the first side of the crucible is heated such that molten glass flows to the opening at the first end of the tubular structure positioned on the second side of the crucible.

6. The induction melter system of claim 1, wherein the heated drain further comprises a plunger.

7. The induction melter system of claim 1, wherein the heated drain further comprises a bulb structure positioned in the drain tube.

8. The induction melter system of claim 7, wherein the bulb structure is heated by the second induction coil to provide a heated surface such that molten glass discharged from the melting vessel flows over the heated surface of the bulb structure.

9. The induction melter system of claim 8, wherein the heated surface of the bulb structure is configured to remove seeds from molten glass discharged from the melting vessel.

10. The induction melter system of claim 1, further comprising a controller configured to control one or more of the current, voltage, or frequency applied to at least one of the first induction coil and the second induction coil.

11. The induction melter system of claim 10, wherein the controller is configured to modify the one or more of the current, voltage, or frequency applied to at least one of the first induction coil and the second induction coil based in part on at least one of:
an amount of glass introduced to the crucible;
an amount of glass fibers produced by a bushing;
an amount of molten glass in a refiner; and
a temperature of one or more of the crucible, the drain, the refiner, or the bushing.

12. The induction melter system of claim 1, wherein the first electromagnetic current generator and the second electromagnetic current generator are the same electromagnetic current generator.

13. The induction melter system of claim 1, wherein the first electromagnetic current generator and the second electromagnetic current generator are different electromagnetic current generators.

14. A system for forming a fiber glass strand comprising:
the induction melting system of claim 1;
a refiner wherein molten glass discharged from the heated drain flows to the refiner;
a bushing wherein the molten glass discharged from the refiner flows to the bushing; and
a winder configured to gather glass fibers formed by the bushing into a strand.

15. The system of claim 14, wherein the refiner comprises a vacuum refiner.

16. The system of claim 14, wherein the refiner comprises a third induction coil positioned around at least a portion of the refiner and a third electromagnetic current generator coupled to the third induction coil such that the electromagnetic current travels through the third induction coil to provide heat to the refiner.

17. An apparatus for melting glass comprising:
a crucible comprising at least one outer wall defining an inner space,
an induction coil positioned around at least a portion of the at least one outer wall of the crucible, and
an electromagnetic current generator coupled to the induction coil such that the electromagnetic current travels through the induction coil to provide heat to the at least one outer wall of the crucible.

18. The apparatus of claim 17, wherein the crucible comprises a Pt—Rh alloy material.

19. The apparatus of claim 17, further comprising an agitator positioned in the crucible.

20. The apparatus of claim 19, wherein the agitator is configured to stir contents of the crucible.

21. The apparatus of claim 19, wherein the agitator releases gas into contents of the crucible.

22. The apparatus of claim 19, wherein the agitator mechanically stirs contents of the crucible.

23. A melter vessel comprising:
a crucible having at least one outer wall defining an inner chamber, the crucible comprising a first body region and a second bottom region, the first body region having a first dimension and the second bottom region having a conical shape;
a plate positioned within the inner chamber of the crucible dividing the first body region of the crucible into a first side and a second side, the plate having a second dimension, wherein the first dimension of the first body region and the second dimension of the plate are substantially the same such that a channel is defined in the second bottom region of the crucible to permit flow of material from the first side of the crucible to the second side of the crucible; and
a tubular structure positioned in the inner chamber of the crucible traversing a portion of the first body region of the crucible and the entire second bottom region of the crucible, the tubular structure having a first end comprising an opening and a second end positioned at a vertex of the conical shaped second bottom region of the crucible.

24. The melter vessel of claim 23, wherein the first end of the tubular structure is positioned in the second side of the crucible.

25. The melter vessel of claim 23, wherein the second end of the tubular structure is coupled to a drain.

26. The melter vessel of claim 23, wherein glass inserted into the crucible on the first side of the crucible is heated such that molten glass flows to the second side of the crucible to the opening at the first end of the tubular structure.

27. A method of making a fiber glass strand comprising:
providing glass material to a crucible;
providing electromagnetic current to a first induction coil positioned around at least a portion of the crucible to heat the crucible;
discharging molten glass from the crucible to a heated drain;
providing electromagnetic current to a second induction coil positioned around at least a portion of the drain to heat the drain; and
discharging molten glass from the drain.

28. The method of claim 27, further comprising:
removing seed from the molten glass in the drain as the molten glass flows over a surface of a bulb structure positioned in the drain.

29. The method of claim 27, further comprising:
providing the molten glass to a refiner that is coupled to the drain;
providing the molten glass from the refiner to a bushing coupled to the refiner to form glass fibers; and
winding the glass fibers formed by the bushing into a strand.

30. The method of claim 27, further comprising:
controlling at least one or more of the current, voltage, or frequency applied to at least one of the first induction coil and the second induction coil by a controller.

31. The method of claim 30, wherein the controller is configured to modify the one or more of the current, voltage, or frequency applied to at least one of the first induction coil and the second induction coil based in part on at least one of:
an amount of glass introduced to the crucible;
an amount of glass fibers produced by a bushing;
an amount of molten glass in a refiner; and
a temperature of one or more of the crucible, the drain, the refiner, or the bushing.

32. The method of claim 27, wherein the crucible produces more than 40 pounds of molten glass per hour.
